(19) United States
(12) Patent Application Publication
(10) Pub. No.: US 2005/0052992 A1
(43) Pub. Date: Mar. 10, 2005

(54) Method and system for dynamically managing cable data bandwidth based on channel congestion state and subscriber usage profile

(76) Inventors: Thomas J. Cloonan, Lisle, IL (US); Carl Daun, Oak Park, IL (US); Max Robbins, Portage, IN (US); Jeffrey J. Howe, West Chicago, IL (US); Steven J. Krapp, Naperville, IL (US); Michael P. Sullivan, Sugar Hill, GA (US)

Correspondence Address: ARRIS INTERNATIONAL, INC, 3871 LAKEFIELD DRIVE, SUWANEE, GA, 30024, US

(21) Appl. No.: 10/910,168

(22) Filed: Aug. 2, 2004

Related U.S. Application Data
(60) Provisional application No. 60/491,727, filed on Aug. 1, 2003.

(51) Int. Cl. H04L 12/26; H04J 1/16; H04L 1/00; H04J 3/14

(52) U.S. Cl. 370/229; 370/252

(57) ABSTRACT

A long-term usage profile and a congestion state metric are used to determine QoS treatment to apply to packets corresponding to a given network user. A user's historical long-term use, measured over one or more periods of time, is used to generate a profile that is compared to one or more predetermined usage threshold level(s). If the usage profile, either singular or composite corresponding to whether one or more than one measurement is used respectively, exceeds the threshold(s), QoS treatment is applied to service flow bytes according to the comparison results during times of network channel congestion. Congestion metrics are determined based on a count of the number of bytes dropped during a congestion measurement window. Either the count itself or the count rate of change combined with the count are compared to a congestion threshold. If the measured/derived values exceed a congestion threshold, the channel is deemed congested.

### CROSS REFERENCE TO RELATED APPLICATION

This application claims the benefit of priority under 35 U.S.C. 119(e) to the filing date of Cloonan, U.S. provisional patent application No. 60/491,727 entitled “Managing subscriber perceptions in the presence of peer-to-peer traffic: a congestion-based usage-based method for dynamically managing cable data bandwidth”, which was filed Aug. 1, 2003, and is incorporated herein by reference in its entirety.

### FIELD OF THE INVENTION

The present invention relates generally to broadband communication, and more particularly to a method and system for dynamically managing the allocation of cable data bandwidth.

### BACKGROUND

Community antenna television (“CATV”) networks have been used for more then four decades to deliver television programming to a large number of subscribers. Increasingly, CATV networks are used by providers to provide data services to subscribers. For example, cable modems used in a broadband cable modem termination system (“CMTS”) compete with digital subscriber lines (“DSL”) and DSL modems used therein, which are typically implemented and supported by telephone companies. DSL service is typically provided over the same wires as a residence's telephone service.

Whether a subscriber uses a cable modem or DSL, peer-to-peer file sharing by users/subscribers is becoming more and more prevalent on the Internet, and the aggregate effect of their high usage level is being felt by network administrators throughout the world. There are many peer-to-peer applications that have appeared on the scene within the last few years, with the largest majority of them being used for file swapping of MP3 music files and digitally-encoded video files. Although the activities are viewed by the music and film recording industries as being direct violations of their copyright privileges, the use of these services continues to rise.

Currently, most peer-to-peer applications use a decentralized model as opposed to a centralized peer-to-peer model. Thus, it is more difficult to “shut down” these networks since many nodes exist that keep the network alive even if a few of the nodes are disabled. In addition, the corporate structures of these peer-to-peer applications tend to be distributed across multiple countries, making it much more difficult to carry out a successful litigation against the companies. As a result, peer-to-peer applications can be viewed by network administrators as un-invited, un-welcomed guests to the Internet party, but are likely to continue. The subscriber base for all of the various peer-to-peer applications easily exceeds a million users already.

However, even a small number of peer-to-peer application users within a large population can generate large amounts of aggregate usage that can skew the expected network statistics, because PCs associated with the peer-to-peer application users may be active as servers and transferring files even when the users are not physically present. These data traffic usage statistics are used in traffic engineering algorithms to balance user-bandwidth usage on a network. File-sharing programs oftentimes run hidden as background processes on a computer without the user even being aware of their operation. In addition, the bandwidth of these services tends to be more symmetrical in nature (upstream bandwidth roughly equals downstream bandwidth) than the typical bandwidth associated with the ‘web-surfing’ downloads that dominated Internet usage a few years ago. As a result, these changes have rendered obsolete the traffic engineering statistics that were assumed when most networks were engineered and are pushing networks to their design limits as they attempt to support peer-to-peer traffic bandwidth.

Surprisingly, the rising number of peer-to-peer application subscribers is not the root cause of the traffic congestion problem. If the peer-to-peer application subscribers “acted like” all other cable data subscribers, there would little problem. In addition, the problem is not even due to the fact that the peer-to-peer users periodically consume bandwidth amounts that approach their maximum allowed bandwidth, thus causing CMTS Quality of Service (“QoS”) mechanisms to typically limit the users to no more than the maximum bandwidth settings within their service level agreements. Even web-surfing applications are guilty of this type of behavior from time to time.

The actual “sin” of peer-to-peer applications results from the fact that they are typically active for a much higher percentage of the time than typical non-peer-to-peer applications. Thus, the peer-to-peer applications are not actually using more than their ‘fair share’ of the bandwidth. Rather, they tend to use their ‘fair share’ of the bandwidth too often.

To aid in describing bandwidth usage, ‘aggregate usage’ for a particular user is defined as the number of bytes transmitted through the network within a given period of time. Thus, the aggregate usage is the time integral of transmitted bandwidth (measured in bytes per second) over a given range of time. For peer-to-peer users, it is common for their daily aggregate usages and monthly aggregate usages to be much higher than the corresponding aggregate usages associated with non-peer-to-peer users, because the amount of time that a peer-to-peer user transmits greatly exceeds the amount of time a non-peer-to-peer user transmits, as shown in FIG. 1.

The effect is that subscribers increasingly tend to ‘chum.’ In other words, subscribers tend to change service providers or even technologies, i.e., from cable data services to DSL. Peer-to-peer application users are on-line and active for such a large percentage of the time that the existing network architectures do not permit all of the users to have acceptable bandwidth levels during periods of congestion. Unfortunately, non-peer-to-peer users who only utilize the channel for a small percentage of the time are finding their probability of using the channel during congested intervals is high due to the presence of the peer-to-peer users, so they perceive the overall cable data service to have lower performance. The lower performance levels experienced by the non-peer-to-peer users may cause them to seek alternate high-speed Internet service providers, causing an increase in subscriber churn for the service providers. It will be appreciated that peer-to-peer application users typically do not cause problems—either for peer-to-peer users or non-peer-to-peer users—during periods when congestion does not exist.

All users have periods of activity and periods of inactivity. The bandwidth used by user A, for example, during a period of activity is a function of user A's application and is also a function of the channel capacity and the traffic from other users that are sharing the channel capacity resources while user A is trying to transmit. The QoS algorithms, which may include mapper, policer, congestion control, fabric scheduler, and other functions known in the art, determine how much bandwidth user A is given relative to the other users during his or her period of activity. If there are few other active users on a channel when user A goes active, then user A will probably experience good performance (even though the channel is shared with the other users). If there are many other active users on a channel when user A goes active, then user A may experience degraded performance along with all of the other users that share the channel. It will be appreciated that different priority levels can cause this effect to be seen differently by different users, because QoS algorithms can be instructed to treat certain users with preference. However, for purposes of discussion, it is assumed that users have the same priority level and the same QoS treatment or QoS policy.

Furthermore, every channel has an associated capacity, and every user application has a maximum desired bandwidth. For purposes of discussion, it is assumed that all user-active applications attempt to transmit data at the maximum rate permitted by their DOCSIS (“Data Over Cable System Interface Specification”) QoS settings. In particular, assume that every user application will attempt to transmit at a rate of Tₘₐₓ=1 Mbps when a given application is active. The sum of the desired bandwidths for all of the user applications will be known as a channel's offered load. If a channel's offered load is less than or equal to the channel capacity, then the channel is said to be in a period of no congestion, or is said to be un-congested.

On the other hand, if the offered load is greater than the channel capacity, then the channel is said to be in a period of congestion, or is said to be congested. During periods of no congestion, all of the users that are actively using the channel should be content, because they should be receiving an acceptable bandwidth level which is equal to the maximum rate (1 Mbps) defined by their DOCSIS Service Level Agreement. However, during periods of congestion, a service provider runs the risk that some of the users that are actively using the channel may become discontented, because they will be receiving a bandwidth level which is less than the maximum rate (1 Mbps) defined by their DOCSIS Service Level Agreement.

From a psychological point of view, most users will tolerate some level of discontent if the periods of congestion are relatively infrequent. But if the periods of congestion become more and more frequent and service levels are continually degraded, then discontent may rise to a level that may cause many cable data subscribers to pursue alternate providers for their Internet service. Thus, periods of congestion should be minimized to reduce subscriber churn.

It is important to note, however, that if the only users who are adversely affected during periods of congestion are peer-to-peer users, then the probability of subscriber churn is likely to be reduced. This is even more evident if the peer-to-peer users are not adversely affected during periods of no congestion. This is due to the fact that peer-to-peer users are less likely to become discontented with the degraded performance during periods of congestion, because they are using the channel so often that they will experience both congested intervals and un-congested, or non-congested, intervals, and their average perception of the service should remain at medium to high levels.

Thus, there is a need for a mechanism for handling peer-to-peer traffic that throttles bandwidth offered to peer-to-peer users during periods of congestion only. During un-congested periods, peer-to-peer users and non-peer-to-peer users should both be allowed to transmit at the maximum rate defined by their respective DOCSIS Service Level Agreement. If peer-to-peer users are throttled during both congested and un-congested periods, then their perception of the service is likely to drop, and they too may be tempted to churn to other service providers. This would be an undesirable result because during un-congested periods, had available bandwidth been made available to the active peer-to-peer users, discontent among those users would have been limited. By offering all of the bandwidth for use during un-congested periods, a service provider can minimize churn among both peer-to-peer users and non-peer-to-peer users, this being an ultimate goal since both types of users are paying customers that generate revenue.

While the fundamental problem is daunting, peer-to-peer traffic provides an opportunity to service providers—the possibility of increased subscriber revenues. Peer-to-peer application users desire large amounts of bandwidth, and if they are managed appropriately, a provider can ensure that they do not become discontented. Thus, peer-to-peer users can become very stable, long-term customers. In addition, if managed properly, providers may be able to extract more revenue from peer-to-peer users who become addicted to peer-to-peer transfers and are willing to pay extra for augmented service levels.

Traffic engineers for a cable data network are challenged to both control peer-to-peer user traffic to keep non-peer-to-peer users content while at the same time trying to keep the peer-to-peer users happy. One of the most difficult tasks for a traffic engineer is developing the traffic engineering models that define how subscribers will likely utilize their network resources. This typically involves the creation of some type of traffic models that define the usage characteristics of “typical” users on the cable data network. The statistics associated with this traffic model might include variable parameters such as:
The number of House-Holds Passed (HHP) connected to a downstream DOCSIS channel on the Cable Data Network (ex: 8000)
The number of House-Holds Passed (HHP) connected to an upstream DOCSIS channel on the Cable Data Network (ex: 2000)
the percentage of House-Holds Passed (HHP) that subscribe for Cable TV Service (ex: 60%)
the percentage of Cable TV subs that subscribe for Cable Data Service (ex: 30%)
the percentage of Cable Data subs that are on-line at any given time (ex: 30%)
the percentage of On-Line Cable Data subs that are simultaneously passing active data (ex:20%)
the average bandwidth for downstream active data transfers (ex: 300 kbps)
the average bandwidth for upstream active data transfers (ex: 100 kbps)

From the example values given above, a typical downstream DOCSIS channel would be required to provide 25.92 Mbps of bandwidth to keep the 1,440 (8000×60%×30%=1,440) cable data subscribers happy. It will be appreciated that in the above example, only 86.4 of the cable data subscribers are simultaneously sharing the bandwidth, which results in an. average bandwidth of 300 kbps for each active data user and an average bandwidth of 18 kbps for each subscribed data user.

From the example values above, a typical upstream DOCSIS channel would be required to provide 2.16 Mbps of bandwidth to keep the 360 cable data subscribers happy. It will be appreciated that only 21.6 of the cable data subscribers are simultaneously sharing the bandwidth, which results in an average bandwidth of 100 kbps for each active data user and an average bandwidth of 6 kbps for each subscribed data user.

Subscribers are assigned to a DOCSIS channel, either upstream or downstream, based on an attempt to meet two conflicting goals. One goal is to minimize the cost of the network infrastructure, which requires the traffic engineer to pack as many subscribers on a DOCSIS channel as possible. The other goal is to minimize subscriber chum, which requires the traffic engineer to assign enough bandwidth to the subscribers so that they are happy with their cable data service and will not be tempted to switch to other alternative Internet Service Providers (such as DSL providers, wireless providers, and satellite data providers, for example).

Meeting the second goal requires complex analysis because there are many variables in the traffic equation. These variables include the total number of cable data subscribers for a given area, the number of cable data subscribers that are on-line at any given time, the number of on-line cable data subscribers that are actively transmitting at any given time, the amount of bandwidth needed for the transfers and the individual psychologies of the users.

In particular, as new applications emerge, any and all of these numbers can vary such that the original traffic engineering assumptions are no longer valid. The emergence of peer-to-peer file-sharing applications provides a real world example of the dilemma. With peer-to-peer traffic on a network, the amount of required bandwidth predicted by traditional traffic engineering models is no longer adequate for the users connected to the DOCSIS channels. Thus, all users may suffer from a lack of bandwidth due to high bandwidth utilization by a relatively small number of peer-to-peer subscribers.

Thus, there is a need in the art for a method and system for facilitating selective bandwidth allocation based on a user's habits to reduce discontent among all users. There is also a need for a method and system that maximizes profits to a service provider based on a user's demand for bandwidth.

### BRIEF DESCRIPTION OF THE DRAWINGS

FIG. 1 illustrates typical aggregate usage of peer-to-peer users versus non-peer-to-peer users.

FIG. 2 illustrates limiting users’ available bandwidth based on usage levels and channel congestion state.

FIG. 3 illustrates a packet-dropping probably graph table where probability of dropping a packet is based on short term activity state and traffic priority.

FIG. 4 illustrates a flow diagram of applying QoS treatment to packets based on a long-term usage profile of a user and a congestion state metric of a data channel.

FIG. 5 illustrates a flow diagram of determining a long-term usage profile.

FIG. 6 illustrates a flow diagram of determining a channel congestion state metric.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. This disclosure is not intended nor is to be construed to limit the present invention or otherwise to exclude other embodiments, adaptations, variations, modifications and equivalent arrangements, the present invention being limited only by the claims appended hereto and the equivalents thereof.

Existing solutions typically fall into the following categories: Increasing bandwidth availability, publicizing the generic problem and requesting voluntary control, identifying heavy users and reprimanding them, fire-walling peer-to-peer traffic, dynamically identifying peer-to-peer traffic with signatures and throttling/blocking the traffic, and supporting a byte-capped billing model with various penalties for exceeding the byte-cap. These attempted solutions have either been ineffective at reducing bandwidth usage, ineffective a reducing chum due to discontent among users whose available bandwidth was involuntarily reduced or penalized.

Rather than identify and penalize users depending on whether they are peer-to-peer users or not, users can be identified as either ‘light’ users or ‘heavy’ users. A heavy user will generally be identified as one whose aggregate usage is much higher than most of the light users. Accordingly, peer-to-peer users will typically be identified as heavy users and non peer-to-peer users will typically be identified as light users, although there is a possibility that some may be identified vice-versa. Regardless, heavy users are the ones that generally cause changes in network statistics.

After users have been identified as either heavy or light, a determination is made as to whether a given channel is in a congested or un-congested state. There are many ways to determine the congestion state of a channel, but it should be understood that a channel will typically have an offered load that is greater than the channel capacity during periods of congestion, and the channel will have an offered load that is less than the channel capacity during periods of non-congestion.

Next, an appropriate QoS treatment for each subscriber/user is determined. To minimize chum among subscribers, both non-peer-to-peer and peer-to-peer subscribers, care should be exercised when making this determination, as a proposed QoS treatment may have a profound psychological effect on the users. For example, one treatment can be applied during periods of non-congestion, and another treatment can be applied during periods of congestion.

During periods of non-congestion, it may be beneficial to permit users to capitalize on the abundant channel bandwidth in order to minimize subscriber chum. In one scenario, a service provider permits any subscriber that wants to transmit data during a non-congested time period to transmit at any rate that is permitted by “fair” usage of the channel, even if that rate exceeds the user's maximum service agreement level determined based on what was agreed to in the agreement when the subscriber signed up for service from the provider. This may also be referred to as priority. In a preferred scenario, a provider permits subscribers to transmit data during a non-congested time period within the bounds of his or her service level agreement settings. This is preferable, because if they get accustomed to the high performance when permitted to go above those levels, they may perceive the decrease in performance associated with being capped at the service agreement level, thus resulting in increased disappointment—and possible churn—when they are eventually limited to lower throughputs due to the presence of other users on the channel. It will be appreciated that this scenario may not result in maximum utilization of the channel's bandwidth resources, or maximum performance to a given user during periods of non-congestion. However, the psychological effect of managing expectations is deemed to be more important than maximizing channel bandwidth utilization efficiency. Thus, in the preferred scenario, different QoS treatment between heavy and light users during periods of non-congestion does not occur. Both are provided bandwidth levels that correspond to their maximum service agreement levels.

Periods of congestion, however, present more complex circumstances. Thus, more than two scenarios are considered. For example, one approach does not provide any differentiation between the QoS treatment of heavy users and light users. With this approach, all users experience service degradation equally. Unfortunately, this approach would likely result in high dissatisfaction among light users, but only minor dissatisfaction among heavy users. Thus, light users are likely to churn.

Another approach lowers the maximum throughput (Tₘₐₓ) levels for heavy users during periods of congestion. This may reduce the amount of bandwidth available to the heavy users, but it may not. This is because all users would probably be throttled back to lower available bandwidth amounts during the congested period. This effect, which is intrinsic to the congestion control algorithms and/or the mapping algorithms in most CMTSs, results in available bandwidth amounts for all users that are much less than their Tₘₐₓ settings. As a result, Tₘₐₓ settings would typically not play a major role in the ultimate assigned bandwidths during periods of congestion.

Alternatively, the preferred approach is to modify the operation of congestion control algorithms and mapping algorithms to ensure that the usage of heavy users is throttled much more heavily than light users during periods of congestion. In fact, light users would ideally experience only a minimal, if any, drop in bandwidth during periods of congestion, and they would still be permitted to transmit within the full bounds of their service level agreement settings. Thus, during periods of congestion, heavy users would be the primary users to be ‘punished’, while light users would continue to receive privileged service levels. Accordingly, light users are typically unaffected by the presence of heavy users during the period of congestion.

Essentially, traffic from light users dominates heavy user traffic. This results in a further decrease in available bandwidth allocated to heavy users and a corresponding increase in data-transfer times experienced by them. At the same time, available bandwidth for light users is essentially unaffected with respect to their ideal offered loads, and thus they experience service levels that are unencumbered by the presence of heavy user traffic.

This approach to traffic management with mixes of heavy users and light users should help reduce overall churn levels, because heavy users will only be slightly disappointed during congestion periods, but they will have also experienced pleasing heavy-usage performance during non-congestion periods on the channel. Light users should experience excellent service performance during most of the infrequent times they use the shared resources—even when there is congestion. Thus, on average, the resulting service experience for heavy users should be good, and the resulting service experience for light users should be even better.

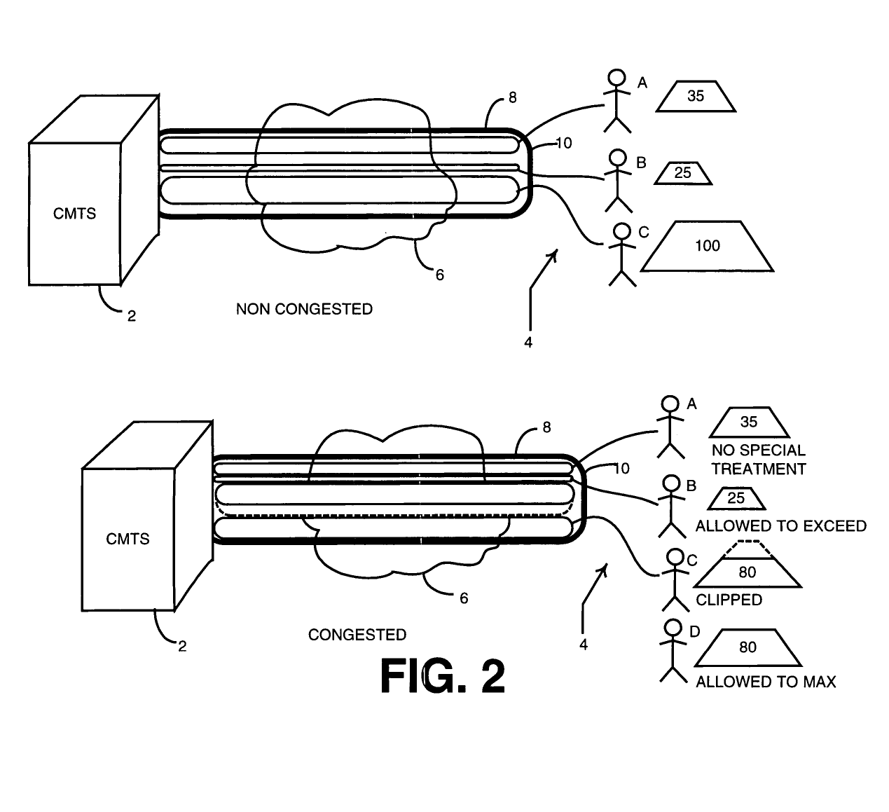

Turning now to the figures, FIG. 2 symbolically illustrates how different classes of users/subscribers are treated under the preferred bandwidth balancing method. The figure shows a CMTS 2 that serves a plurality of users/subscribers 4 via a network 6, such that the network communication between subscribers 4 and CMTS 2 is provided by channel 8. Channel 8 is represented by thick lines to distinguish the channel from individual data paths 10, corresponding to subscribers 4.

The figure is said to symbolically illustrate treatment because it does not depict an actual physical embodiment. For example, a channel could be either an actual connection physically separate from others or a virtual channel in an arrangement where multiple virtual channels are supported by a single physical connection. Thus, channel 8 is symbolically depicted as a ‘pipe’ that supports different streams of data that can vary in size and number within the pipe. In addition, weight symbols of varying size and weight are placed next to subscribers to proportionally represent whether a user is a heavy user or a light user. For purposes of discussion relative to the figure, it is assumed that users A and B have maximum service agreement levels of 50, user C has a maximum level of 100 and user D has a maximum level of 80.

In the upper half of the figure, which illustrates a non-congested channel state, empty space is shown between the data streams 10 to represent that there is bandwidth available in addition to what the streams are using. In the bottom half of the figure, which illustrates a congested channel state, only a small amount of space for clarity purposes is shown between data streams 10, thus representing that all of a channel's bandwidth is presently being used, or is at least allocated to a given subscriber. The broken lines depicting the data stream associated with user C in the bottom half represents the maximum service agreement level has been throttled because the past usage weight was 100. Accordingly, user A is not throttled because of past light usage. New user D is allowed to go to their max agreement level because they have very light past usage—they were not using any bandwidth during the non-congested period. Finally, user B is allowed to exceed their service agreement level because of very light past usage. It is noted that in the discussion above, the preferred treatment is to limit all users to their maximum service agreement level to avoid negative perceptions for light users when they are using during a period of congestion. Rewarding user B by allowing them to exceed their service agreement level is shown for purposes of illustrating what is possible, but not what is preferred. In the preferred embodiment, user B will also be limited to their service agreement level of 50.

Since FIG. 2 illustrates a general overview of the results of the preferred bandwidth management aspect, a more detailed description follows. As described above, the CMTS modifies QoS treatment for users, and these modifications are made as a result of monitoring the usage levels for each of the users and also monitoring the congestion levels within the channels. In general, the aspect comprises three separate functions. First, subscribers are classified into different groupings based on their long term usage levels. Although for clarity two long term usage levels were defined above—one for heavy users and one for light users—it will be appreciated that more than two usage level groupings are possible and may be desirable. In addition, it will be appreciated that the classifying step can be performed within the CMTS or within a sub-system outside of the CMTS. In either case, this function continually collects long-term and/or short-term usage statistics for each of the users and these statistics are used to continually update the mapping of a user into one of the groupings.

After classification of subscribers into long term usage groupings, identification of the channel congestion state based on the channel utilization, or other key congestion identifiers, is performed. It will be appreciated that for clarity in the description above, two congestion states were defined - one for congested periods and one for non-congested periods. However, more definitions with more than two congestion states can implemented. This function is preferably performed within the CMTS itself as the congestion state of a channel is dynamic and may continually change. Thus, the responsive treatment (i.e., applying a different QoS treatment to a user's data service flow rate) as a result of a change in the congestion state is typically implemented very rapidly (on the order of a few milliseconds) to produce the psychologically desirable results vis-a-vis the users. Therefore, a sub-system outside of the CMTS to implement the change in the QoS treatment may be less desirable.

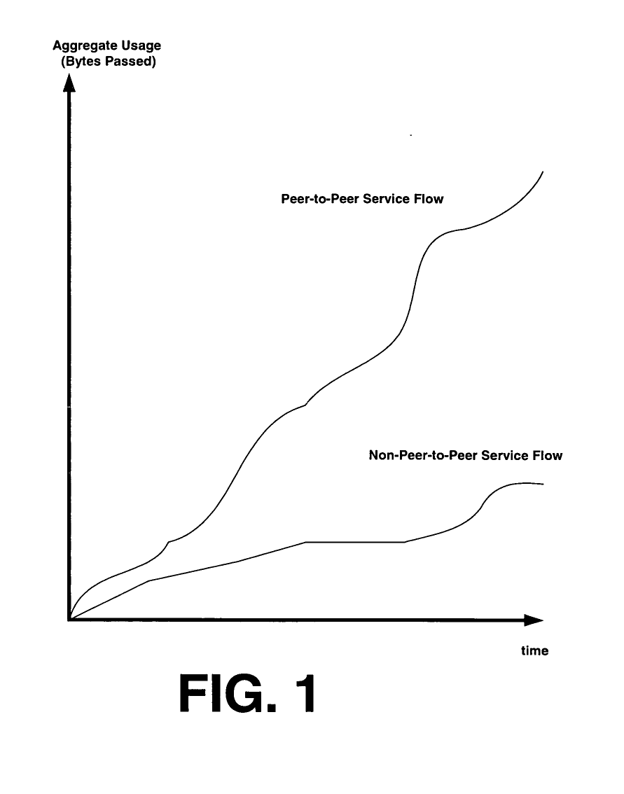

Application of a QoS treatment according to the preferred aspect to a given user's data stream is typically made to ensure that all users end up with a positive psychological perception of the service. The QoS treatments are preferably implemented within the CMTS, because the network infrastructure, represented by reference 6 in FIG. 1, which is preferably a hybrid fiber coax (“HFC”) plant, as known in the art, is a likely point of congestion for user traffic. The CMTS administers traffic flow control within the network infrastructure.

### Classification of Subscribers into Different Groupings Based on Their Usage Levels

Different ways exist to classify subscribers into different usage level groupings. The complexity of the different approaches can range from difficult to easy. Ideally, the classification helps determine the contentment level for each user with the goal being to ensure that a maximum number of users end up with an acceptable contentment level.

In general, the classification step uses long term historical traffic patterns, or profiles, associated with each user over a period of time, or ‘window’. The window of time used to sample the historical traffic profiles is selected to maximize user contentment. If the measurement window is too short, then light users who are simply bursting data on the channel for a short period of time may be incorrectly identified as heavy users. If the measurement window is too long, then heavy users will be allowed to operate in their problem-causing manner for much too long before their QoS treatment is modified, thus resulting in detrimental effects on light user's traffic until the window closes. Additionally, a heavy user who switches their behavior pattern and becomes a light user would not have their QoS treatment modified for quite a while, thus being punished as a heavy user for much too long and resulting is decreased satisfaction.

Accordingly, the question becomes, ‘what window periods should be used to differentiate between heavy and light users?’ Before answering that question, several points are noted. First, the duration of a window used to classify heavy and light users will also define to some extent the duration of the punishment, or penalty, period during which a user's QoS treatment is negatively manipulated, or throttled. This is due to the fact that recognition of improved behavior will likely require a similarly sized window.

Window periods less than or equal to a few seconds are probably too short. This is because even light users who periodically download a weather map from the Internet will have bursts of heavy usage that last for a few seconds and would inaccurately be classified as heavy users. Thus, following the close of the sample widow, they would be penalized for heavy usage, although they are in general light users. While the penalty period may also be similarly short, as discussed above, any penalty may cause a light user to have a reduction in perceived satisfaction. Since the preferred outcome is to avoid penalizing a typically light user, lest he or she decides to switch to a different type of service, a window that is too short is not desirable.

Accordingly, window-length periods on the order of an hour, a day, or a month are preferable for controlling peer-to-peer traffic. It will be appreciated that there may be situations where a shorter widow may be desirable, however, as in the case of severe weather affecting a specific region, in which case the CMTS may set a shortened time period so that even the typically classified light user downloading a weather map described above may be considered heavy. This would provide extra bandwidth so others can also download the weather map.

As with the light user downloading a weather map when the weather outside is not frightful, some peer-to-peer users may periodically download a file for a few minutes and then reduce bandwidth usage. This usage behavior should not be “punished.” For example, progressing along the use/abuse spectrum, a peer-to-peer user who downloads files for an hour is on the fringe of system abuse, so they should incur some level of short-term ∓punishment” in the form of modified QoS treatment (reduced bandwidth availability) about an hour.

A peer-to-peer user who downloads files for a whole day will typically be classified as abusing the system (unless there is ample bandwidth for all other users even with the user's consumption of a large amount of bandwidth). Thus, their usage will be penalized even more in the form of modified QoS treatment for a day or so. It then follows that a peer-to-peer user who almost constantly uploads or downloads files for a whole month will typically be classified as a major abuser of the system, so they will typically be penalized by negative QoS treatment for a month or so.

In order to accommodate all of the different forms of punishment, or penalties, described above, three different state variables, for example, can be maintained for each user. One state variable could monitor usage over one-hour windows, and it could be re-calculated once every 10 minutes, for example. The second state variable could monitor usage over one-day windows, and it could be re-calculated once every four hours, for example. The third state variable could monitor usage over one-month windows, and it could be re-calculated once every five days for example. These state variables could then be used to store a measure of the long-term usage for each of the monitored periods (an hour, a day, and a month).

To determine these state variables, use of an expected maximum usage rate can be defined for each user. This usage rate can be used to set an initial byte-cap value. For example, a monthly downstream byte-cap for a particular user of 30 Gbytes may result in the user being defined as “well-behaved” if they consume bandwidth at a long-term rate of no more than 30 Gbytes/month=1 Gbyte/day=1 Gbyte/86400 sec=11.5 kbytes/sec. A dialy downstream byte-cap for a particular user of 2 Gbytes would result in a user being classified as “well-behaved” if they consume bandwidth at a long-term rate of no more than 2 Gbytes/day=23.1 kbytes/sec. Or, an hourly downstream byte-cap for a particular user of 128 Mbytes would result in a user being classified into a “well-behaved” group if they consume bandwidth at a long-term rate of no more than 128 Mbytes/hour=35.5 kbytes/sec.

Using this information, the three required state variables can be defined using a form of a leaky bucket algorithm, which is known in the art. For purposes of example, it is assumed that the state variables Sₕₒᵤᵣ(t), S_{day}(t), and Sₘₒₙₜₕ(t) represent the state variables associated with hourly usage, daily usage, and monthly usage, respectively. Assuming that P bytes have been consumed by the user in a given time window W (measured in seconds), the simple formula for the state variables can be developed as follows:
Sₕₒᵤᵣ(t+W)=Sₕₒᵤᵣ(t)+P−(35.5 kbytes/sec)(W)
S_{day}(t+W)=S_{day}(t)+P−(23.1 kbytes/sec)(W)
Sₘₒₙₜₕ(t+W)=Sₘₒₙₜₕ(t)+P−(11.5 kbytes/sec)(W)

These state variable calculation results are bounded between a maximum positive value and a minimum negative value (maximum magnitude in the negative direction with respect to the origin on a number line). If the expression representing the actual usage (P) during the window minus the byte-cap amount allowed during the window is negative, then the user's total bytes used during the window period W was less than the service agreement byte-cap for that user. If positive, then the user used more bytes than allowed during the window period. Thus, using less than the byte-cap amount downwardly biases the S(t) state variable and using more upwardly biases the usage state variable. It will be appreciated that each user will preferably have three state variables defining their long-term usage of the upstream channel and three state variables defining their long-term usage of the downstream channel, so six state variables are preferably stored for each user.

It will also be appreciated that a cable modem may normally be considered a user or subscriber with respect to the CMTS. However, for a given cable modem that is shared by more than one physical user who accesses the CMTS, and thus a network, with identifiers, such as a username and password, each actual user may be assigned their own state variables. This could prevent a light user from having an unpleasant usage experience because of another's heavy usage when the heavy user is not ‘logged on.’ Of course, if the heavy user is logged on simultaneously with the light user, the overall bandwidth usage of the cable modem would typically be considered because the data streams of both users would typically share the same channel, for which the traffic engineering method attempts to balance.

Mapping users (or cable modems) into appropriate groupings can then be accomplished using the three state variables that are monitored for each user. Assume a desired threshold level is defined for each of the state variables. In particular, Lₕₒᵤᵣ, L_{day}, and Lₘₒₙₜₕ can be used to represent the three thresholds. It will be appreciated that the threshold values will typically be non-negative values. At any given point in time, if Sₕₒᵤᵣ>Lₕₒᵤᵣ, then the user is said to be in violation of the hourly byte-cap. Similarly, at any point in time, if S_{day}>L_{day}, then the user is said to be in violation of the daily byte-cap and if Sₘₒₙₜₕ>Lₘₒₙₜₕ, then the user is said to be in violation of the monthly byte-cap.

Given these definitions, users can be segregated into four different groupings: ‘super-light’ users, ‘light’ users, ‘heavy’ users, and ‘super-heavy’ users. In particular, super-light users could be defined as users that are not in violation of any of their byte-caps. Light users could be defined as users that are in violation of exactly one of their byte-caps. Heavy users could be defined as users that are in violation of exactly two of their byte-caps. Super-heavy users could be defined as users that are in violation of all three of their byte-caps.

The state variables can be calculated within the CMTS, but care should be exercised. In particular, clever users might try to trick the grouping function by periodically power-cycling their cable modems, causing the modem to re-range and re-register. These operations would likely give the cable modem a new IP address and new service flows, so any statistic counts that are collected using service flow counters should be aggregated across power-cycles on the cable modem. This implies that the aggregation software should be cognizant of the MAC address of the cable modem when creating final counts, and should have access to counters for now-deleted service flows that were previously associated with the same cable modem before a power-cycle event. This precaution can be satisfied by adding the count aggregator in the CMTS, but it can also be satisfied by adding the count aggregator in a server upstream of the CMTS. The latter approach may be preferred because the server can have visibility into all CMTSs on the network plant. This provides the advantage that if a cable modem happens to re-range on a different CMTS, the external server should still be able to correctly aggregate the counts across the multiple CMTSs.

### Importance of the Activity State Variable

In addition to the long term usage profile associated with a particular user, the activity state (Needy, Normal, Greedy, and Super-Greedy) of a packet is an important input to both the mapping algorithm and the Activity Sensitive-Weighted Random Early Detection algorithm, as described in U.S. patent application Ser. Nos. 09/902,121 and 09/620,821, which are herein incorporated by reference in their entireties. The activity state describes the short-term bandwidth usage of a particular user (service flow). Thus, it should be clear that dramatic modifications to a packet's QoS treatment can be obtained if the activity state is further modified to incorporate the concept of long-term bandwidth usage profiles as well as short-term bandwidth usage activity state variables.

To determine the activity state variable, the instantaneous bandwidth associated with each service flow is monitored (using 1-second sliding sampling windows implemented with a leaky bucket). This value is compared against three thresholds defined by the service flow's QoS settings. The three thresholds are the minimum guaranteed throughput (Tmin), the maximum throughput (Tmax), and a defined threshold known as Tmid, which is the mid-point between Tmin and Tmax. If the current instantaneous bandwidth is less than or equal to the minimum throughput setting (Tmin) for the service flow, then the service flow's activity state is said to be in the “Needy” state. If the current instantaneous bandwidth is greater than the minimum throughput setting (Tmin) but less than or equal to Tmid for the service flow, then the service flow's activity state is said to be in the “Normal” state. If the current instantaneous bandwidth is greater than Tmid but less than or equal to the maximum throughput setting (Tmax) for the service flow, then the service flow's activity state is said to be in the “Greedy” state. If the current instantaneous bandwidth is greater than the maximum throughput setting (Tmax) for the service flow, then the service flow's activity state is said to be in the “Super-Greedy” state.

The activity state can be modified as follows. In a first way, service flows that are identified as super-light or light would not be changed. Service flows that are identified as heavy or “super-heavy” would have their activity state demoted by one or two levels, respectively. Thus, a heavy service flow with an actual activity state of “needy” would be demoted by one level to have a new activity state of “normal.” A “super-heavy” service flow with an actual activity state of “needy” would be demoted by two levels to have a new activity state of “greedy”. As a result of these demotions, service flows that are heavy or “super-heavy” users will typically experience congestion drops (during periods of congestion) more often than light of “super-light” users.

In a second way, rather than re-defining the activity state definitions (Needy, Normal, Greedy, and Super-Greedy) described in the previous paragraph, the definition of Tmid may be changed such that the Tmid value is controlled by the long-term usage state of the user. In particular, if a user is a “super-light” user, then the original Tmid value can be used. If a user is a light user, then the Tmid value can be lowered to be a value that is some provisionable fraction (e.g. 0.85) of the original Tmid value. If a user is a heavy user, then the Tmid value can be lowered to be a value that is some provisionable fraction (e.g. 0.70) of the original Tmid value. If a user is a “super-heavy” user, then the Tmid value can be lowered to be a value that is some provisionable fraction (e.g. 0.55) of the original Tmid value.

By moving the Tmid value down as the user's long-term usage increases, the user is classified as a greedy user at much lower instantaneous bandwidths. That is the penalty for being classified as a heavy user, as greedy users are treated with lower precedence than needy and normal users during periods of congestion. At the same time, this permits a user to transmit up to their defined Tmax value as long as the channel congestion state permits it.

### Upstream Mapping Function

For each upstream service flow passing through the CMTS, an appropriate number of bandwidth grants are assigned so that the upstream service flow's data is properly mixed with the other upstream service flows on the shared upstream channel.

The preferred mapping algorithm currently assigns an arriving bandwidth request from a particular service flow into one of several different queue categories. This assignment is based on both the short-term activity state, or usage level (needy, normal, greedy, or super-greedy) and the Priority Level for the service flow. Requesting packets are funneled into the correct queue based on service flow priority level and short term bandwidth utilization (needy, normal, greedy, and super-greedy). The mapper promotes aged requests from greedy queues to normal queues and from normal queues to needy queues. Thus, needy subscribers are serviced with a higher priority than normal and greedy subscribers. Super-greedy subscribers may have their bandwidth requests dropped. The aging rate is proportional to the Tmin setting for the service flow.

### Identification of a Channel's Congestion State Based on the Channel Utilization and/or Key Identifiers

The complexity of the different approaches to identify channel congestion state ranges from easy to difficult. Preferably, the identification occurs in real-time to identify when a given user's demand for instantaneous bandwidth on a channel causes the channel's maximum capacity to be exceeded. The identification is typically performed separately for upstream and downstream channels.

Typically, the downstream channel in the HFC plant is the primary point of congestion in the downstream direction. In general, the identification of congestion in the downstream direction relies on real-time measurements within the CMTS. For the downstream channel in the HFC plant, the CMTS can monitor the operation of the Fabric Control Module's (“FCM”) Activity Sensitive-WRED congestion control algorithm as it processes packets destined for downstream Cable Access Module (“CAM”) ports. The FCM is a circuit card within the CMTS that provides switching fabric functionality. It steers packets to their desired output ports by examining the destination IP addresses on the packets. The CAM is a circuit card within the CMTS that provides connectivity to the HFC plant.

If the FCM employs a counter which keeps track of the number of packets that were dropped due to congestion control, this counter can be used to help determine when the downstream channel is entering a period of congestion. In particular, the downstream channel would be defined to be congested if the count exceeds a configurable threshold value within a predetermined period of time, such as, for example, 500-milliseconds. In the previous example, the congestion state would be sampled every 500 milliseconds. In another aspect, a weighted combination of the counter and the derivative (rate of change) of the counter are calculated. The derivative over a time window T can be approximated by counting and storing the number of bytes dropped in a first time window, resetting the count variable and counting the number of bytes dropped in a second time window, and dividing the difference of these two values by the time period T.

In the upstream direction, congestion may typically occur at several points within each channel. Two typical points of congestion are by the CMTS. The first of these is on the upstream channel in the HFC plant. The second of these points is at the egress port that carries traffic from the CMTS. It will be appreciated that these egress ports can be upstream Network Access Module (“NAM”) ports or downstream CAM ports. The NAM is a circuit card within the CMTS that provides connectivity to the HFC plant.

Accordingly, in general, real-time measurements taken within the CMTS for both of these congestion points are used to determine when a given upstream channel is congested.

In addition, for the upstream channel on the HFC plant, the CMTS can monitor the operation of the CAM's mapper. The CAM mapper keeps track of the number of ‘needy’ and ‘normal’ bandwidth requests that received grant pending responses. This counter can then be used to help determine when the upstream channel is entering a period of congestion. For example, if the count exceeds a predetermined threshold value within a 500-millisecond period of time, then the upstream CAM channel would be defined to be congested. As with the downstream channel, in the previous example, the congestion state would be sampled every 500 milliseconds. In another aspect, a weighted combination of the counter and the derivative (rate of change) of the counter are calculated. The derivative may be determined as described above.

For the upstream channel at the egress port, the CMTS determines the destination of a particular packet. Different packets from even the same user may be destined for different egress ports, so the current congestion state for the upstream channel is calculated after the egress port for a particular packet is identified by the routing table/ARP cache look-up on the FCM. Once the egress port is identified, the CMTS can monitor the operation of the FCM Fabric's WRED Queue Depth in a fashion similar to that done by the Activity Sensitive-Weighted Random Early Detection algorithm, as described above and in U.S. patent application Ser. Nos. 09/902,121 and 09/620,821.

The WRED Queue Depth accounts for the depth of the FCM shared memory as well as the depth associated with the particular egress port. This WRED Queue Depth can be used to help determine when the egress port is entering a period of congestion. For example, if the WRED Queue Depth exceeds a configurable threshold value, then the egress port would be defined to be congested. This calculation is typically implemented in the FCM in every super-page interval for every egress port. Thus, state variables corresponding to each egress port is used. In another aspect, a weighted combination of the counter and the derivative (rate of change) of the counter are calculated. The derivative over a time window T can be approximated by the value [COUNT(end of window)-COUNT(start of window)]/T).

Preferably, the definition of the upstream channel's congestion state is a weighted combination of the upstream CAM channel's congestion state and the associated egress port's congestion state. In a simple model, the upstream channel can be defined to be in the congested state (for a particular packet) if either the upstream CAM or the egress port for this packet are found to be in the congested states.

### Assignment of QoS Treatment

After the congestion state has been determined, there are a variety of ways to specify the QoS treatment to be applied to packets of a particular user to help ensure that user perceptions of the service are positive. In general, when a particular packet from a particular user arrives at the CMTS, its QoS treatment will be a function of conventional QoS functions performed by a CMTS that are known in the art. These existing conventional functions may include, for example, an upstream mapping algorithm (which accounts for short-term user greediness, user priority, and upstream channel congestion), a policing algorithm (which accounts for short-term user greediness and user throughput settings), an Activity Sensitive-WRED congestion control algorithm (which accounts for short-term user greediness, user priority, and egress port congestion), and a Latency Sensitive Scheduling algorithm (which accounts for user latency requirements and egress port congestion).

These existing QoS functions do a good job of controlling and fairly managing the bandwidth using short-term usage statistics. However, they do not yet take into account the long-term usage statistics that are indicative of the peer-to-peer problem discussed above. Thus, an aspect adds long-term usage statistics into the existing QoS functions. These modified QoS functions will still manage bandwidth using short-term statistics, but will also intelligently manage bandwidth using the long-term statistics to create the desired positive user-perception for both peer-to-peer users and non-peer-to-peer users, even in the presence of peer-to-peer traffic.

The particular long-term statistics that are used include the statistics described above related to classifying a user into a group based on that user's long-term usage level or profile. Preferably, the user's long-term historical usage profile over a predetermined period of time will be used. It is again noted that although four different user usage states were defined above—‘super-light’, ‘light’, ‘heavy’, and ‘super-heavy’—more or less usage level profiles can be used. In addition, the channel's congestion state will also be used. Similarly, although two congestion states were defined for each channel state—congested and non-congested—more or less congestion states could also be used. Thus, each packet passing through the CMTS has associated with it two more state variables—the long-term usage level state and the channel congestion state. In general, the objective is to ensure that during periods of non-congestion, the CMTS continues to operate according to conventional treatment algorithms. That is, treating all users equally well regardless of their long-term usage state. However, during periods of congestion, using the usage level profile and congestion state variables provides preferential treatment to super-light users and light users, but heavy users and super-heavy users may be penalized. The penalties, or punishment, may include delayed grants for upstream bandwidth requests at the mapper and dropped packets in the Activity Sensitive-Weighted Random Early Detection congestion controller.

To facilitate merging these long-term statistics into the existing QoS functions, some of the parameters in the CMTS mapper and a CMTS's Activity Sensitive-Weighted Random Early Detection algorithm may be modified. While a detailed description is not needed, a brief overview of the existing Activity Sensitive-Weighted Random Early Detection algorithm follows the even more brief description of the upstream mapping function.

### Activity Sensitive-Weighted Random Early Detection Congestion Control Function

Packets are mapped into a service flow and service flow data streams passing through the CMTS are congestion-controlled to limit the number of packets that are injected into the CMTS's shared memory fabric when the fabric has become congested. Packet congestion can occur whenever ‘bursty’ traffic destined for a particular output port is injected into the fabric. In general, congestion control typically performs random packet dropping to minimize the flow of bandwidth into a congested fabric, and it helps prevent fabric over-flowing. Congestion control is performed on service flows for upstream cable channels and incoming Ethernet ports before the packet is injected into the shared memory fabric. Thus, congestion control provides protection against fabric (memory buffer) overloading, which could result in lost data.

Preferably, a CMTS employs an advanced congestion control algorithm that can use both current bandwidth state information for the packet's specific service flow and fabric queue depth information to determine the dropping probability for each packet. The network administrator can configure the congestion control settings to enable dropping according to the Random Early Detection (RED) algorithm, the Weighted Random Early Detection (WRED) algorithm, or an Activity Sensitive-WRED algorithm as described in U.S. patent application Ser. No. 09/902,121 and 09/620,821, which are incorporated herein by reference in their entireties.

The RED approach performs random packet dropping as a function of fabric queue depth. The WRED approach performs random packet dropping as a function of fabric queue depth and the priority associated with the packet's service flow. The Activity Sensitive-WRED approach performs random packet dropping as a function of fabric queue depth, the priority associated with the packet's service flow and the current bandwidth state information associated with the packet's service flow.

A new addition to the per-service flow congestion control algorithm is the use of an effective smoothed fabric depth (Deff) in place of the previously-used smoothed fabric depth (Dsmooth). The previously-used smoothed fabric depth used a smoothed version of the fabric depth as defined in the theoretical paper defining the WRED approach to congestion control (Floyd, S., and Jacobson, V., Random Early Detection gateways for Congestion Avoidance, IEEE/ACM Transactions on Networking, V.1 N.4, August 1993, p. 397-413).

However, that paper assumed that there was a single output buffer as opposed to a shared memory fabric for buffering of packets. A shared memory fabric offers many benefits over a single output buffered system (such as lower overall cost, more efficient utilization of memory, etc.), but the WRED algorithm is modified to recognize that a shared memory fabric is being used. In particular, the design is modified to take into account the effect of having a packet enter the system destined for an idle output port when a second output port is being overloaded by traffic (which is leading to increased total queue depth within the shared memory fabric).

Ideally, the packet destined for the first output port should not be affected by the large queue developing at the second output port—only traffic destined for the second output port should experience the WRED drops that may result from the buffer build-up. The use of an effective smoothed fabric depth in place of the smoothed fabric depth should produce this result. For a CMTS that has 32 output ports, the total shared memory fabric depth is given by Fab_Size, and under ideal operating conditions, each output port would use approximately Fab_Size/32 words within the fabric. However, it should be understood that shared memory fabrics are designed to temporarily permit one or more of the output ports to “hog” more of the buffer depth than the other output ports, so under normal operating conditions, a single output port might consume K*Fab_Size/32 words within the fabric, where a typical value of K might be 2 or more. Thus, one might argue that as long as the queue depth associated with one output port remains less than or equal to 2*Fab_Size/32, that output port's effective smoothed fabric depth should not be penalized with a larger weighting when compared to the previously-used smoothed fabric depth. However, when the queue depth associated with an output port becomes greater than 2*Fab_Size/32, then the output port's effective smoothed fabric depth should be penalized and increased by a scaling factor so that packets destined for that backed-up output port will be dropped more often than packets destined for “quiet” output ports. One way to ensure this behavior is to scale the previously-used smoothed fabric depth with the scaling factor:
(Port Depth*32)/(2*Fab_Size),
where Port_Depth is the queue depth associated with the port to which the current packet is destined.

Thus, one can calculate the newly-defined effective smoothed fabric depth (Deff) to be:
Deff=Dsmooth*(Port_Depth*32)/(2*Fab_Size),
where Dsmooth is the smoothed fabric depth as implemented in the first version of the C4 CMTS. (Note: This implies that the congestion control algorithm be cognizant of Fab_Size, Dsmooth, and the 32 Port_Depth values for the 32 output ports. In addition, the congestion control algorithm must be cognizant of the actual instantaneous Fabric Depth (Dactual) to permit it to drop all packets whenever the Dactual value rises too high).

To determine when a packet should be dropped due to congestion control, the algorithm queries a table of dropping probability graphs to acquire a dropping probability for each packet. The query uses the short-term activity state (Needy, Normal, Greedy, and Super-Greedy) along with the packet priority level as keys to find the desired dropping probability graph. Within the selected graph, the current Fabric Depth (congestion state?) is used as a key to determine the desired dropping probability. The algorithm then generates a random number and uses the desired dropping probability to determine if the packet should be dropped or not.

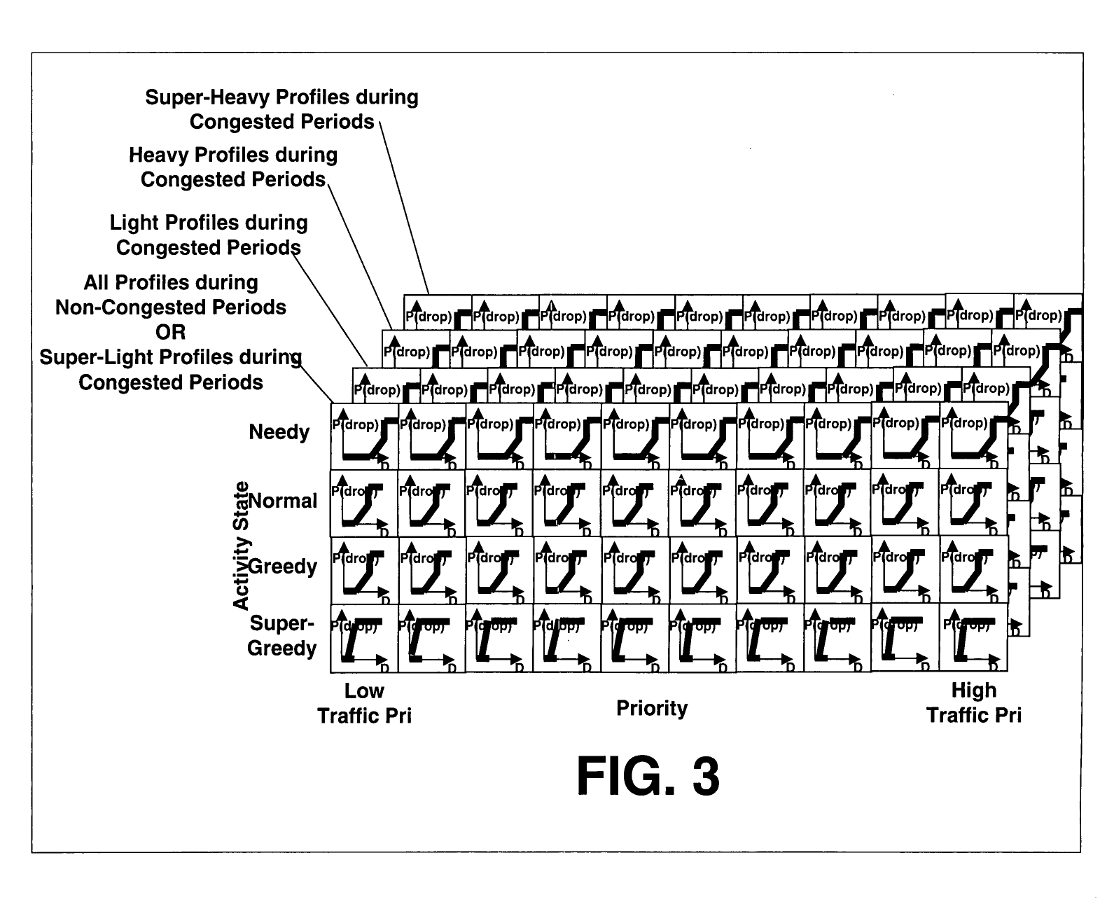

A typical dropping probability graph table is shown in FIG. 3. As shown in the figure, packets with higher activity states and lower priorities are more likely to be dropped than packets with lower activity states and higher priorities. The front chart in the figure is a two-dimensional chart representing QoS treatment based on a period of non-congestion. It will be appreciated that a third dimension perpendicular to the surface of the sheet corresponds to congestion state/long term profile. The chart in FIG. 3 has as many layers in this third dimension as there are long-term profiles used to determine how to treat packets from a particular subscriber at a particular time. Moreover, during a condition of non-congestion, every user will have QoS treatment applied to their packets based on the front chart. However, during periods of congestion, users other than those having the lightest long term profile will have QoS treatments applied based on successive layers into the page associated with their corresponding long term usage profile. As discussed above, users having the very lightest long term profiles are preferably treated the same regardless of congestion state. In addition to activity state and priority level, packets are more likely to be dropped during periods of congestion as opposed to periods of no or low congestion.

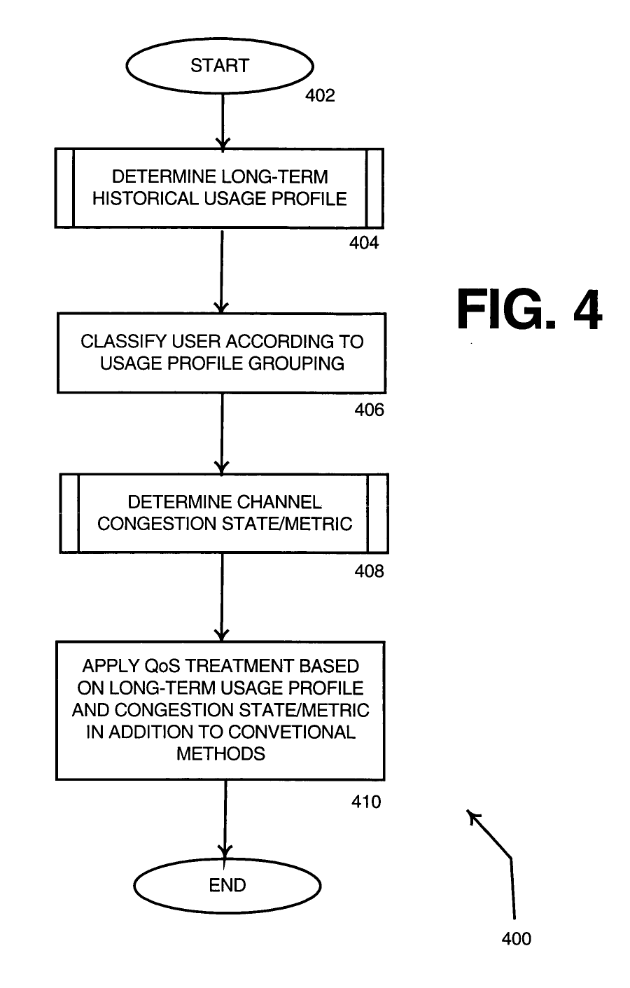

Turning now to FIG. 4, a flow chart for administering, applying, or assigning, (these three terms may be used interchangeably herein in reference to treating packets of a user) QoS treatment to packets based on the long-term usage profile of the subscriber associated with them and the channel congestion state, or metric, associated with the channel over which the packet is being transmitted. Routine 400 starts at step 402 and then proceeds to step 404, which is a subroutine for determining the long-term usage profile. After the profile has been determined, the user associated with the packet is classified into one of several groups based on the profile. The congestion state, or metric, of the channel transmitting the packet is determined by subroutine 408. After the long-term profile and channel congestion state have been determined, QoS treatment is applied to the packet according to conventional QoS functions. In addition, the long term historical usage profile as determined at step 404 and channel congestion state as determined at step 408 are applied to the packet or packets composing a data stream.

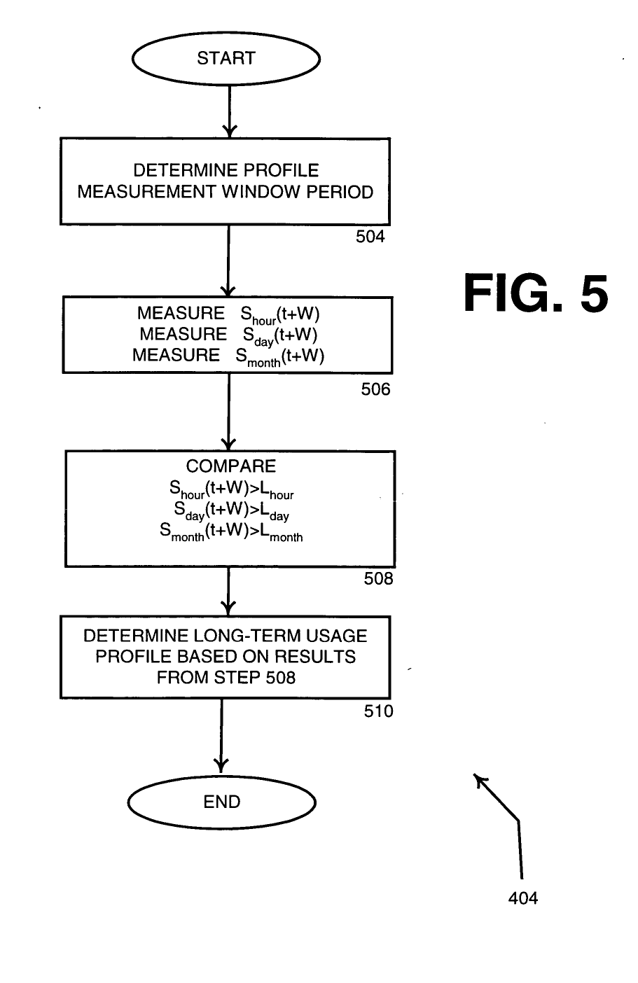

FIG. 5 details the steps in determining the long-term usage profile used in step 404. First, a period of time for taking measurements is determined at step 504. Preferably, periods of time are determined so as to result in more than one measurement statistic, or metric. These periods are referred to as corresponding usage profile windows. For example, one window may be based on measurement of number of bytes used over a one-hour period. The mathematical formula used to determine the function Sₕₒᵤᵣ(t+W) is described in greater detail above in the section entitled Classification Of Subscribers Into Different Groupings Based On Their Usage Levels. Similarly, functions for S_{day}(t+W) and Sₘₒₙₜₕ(t+W) may be determined and used in conjunction with one another to result in an overall longterm usage profile that is associated with a given subscriber. The S(t+W) functions may be determined discretely, that is, from a time zero, Sₘₒₙₜₕ(t+W) is only determined at one-month intervals, and S_{day}(t+W) and Sₕₒᵤᵣ(t+W) are only determined at one-day and one-hour intervals respectively.

Alternatively, each of these functions may be updated at a smaller interval of time. For example, each variable may be updated every hour. Thus, for example, Sₘₒₙₜₕ(t+W) could be updated every hour to reflect the usage history of the given user over the immediately preceding one-month period.

After the S(t+W) functions are determined, they are compared to corresponding L threshold values. If an S(t+W) function is greater than the corresponding L threshold, then the subscriber is deemed to be heavy with respect to the window period used. It will be appreciated that a single S(t+W) function profile may be compared to its corresponding L threshold value. Alternatively, a composite S(t+W) profile that includes a combination of S(t+W) functions corresponding to a plurality of corresponding usage profile windows may be compared L threshold values corresponding to the same usage profile windows to determine whether a user is light or heavy, or some other designation instead of, or in addition to, light and heavy. Thus, a user may be heavy with respect to the past hour, but light with respect to the past day and month, as in the scenario described above where a user rarely access the network but is attempting to download a weather map.

In determining the long-term usage profile at step 510, each time-period-comparison may be assigned a weight so that, for example, a user who has been heavy during the past hour, but has been light over the past day and month may not be classified as heavy a user as one who has been very light for the past hour, but has been heavy for the past month. Thus, a traffic control engineer can assign weight values, for example, to each of the the S(t+W) vs. L comparisons to shape congestion control in a specific manner. As discussed above, the long-term usage profile is used at step 406, as shown in FIG. 4, to classify a user according to their corresponding usage profile grouping.

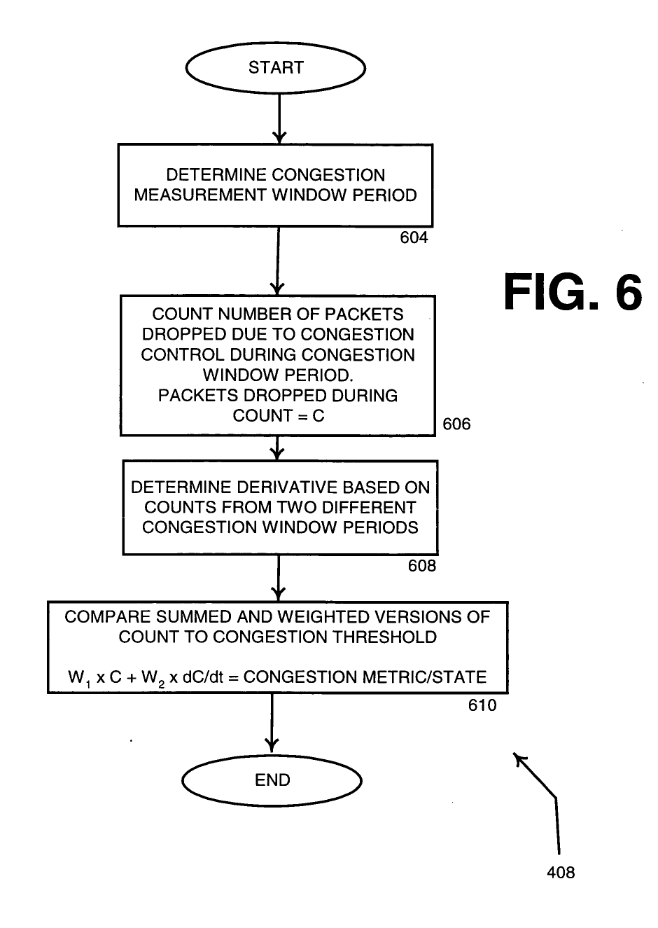

Turning now to FIG. 6, the detailed steps of determining the channel congestion state, which may also be referred to as channel congestion metric, is shown. The result is passed back to routine 400 at step 408, as shown in FIG. 4. Continuing now with reference to FIG. 6, as with determining the usage profile, a window having a predetermined period is used to measure the congestion state. At step 604, the predetermined congestion measurement window period is determined. This time can vary, but the preferred congestion window period is 500 milliseconds. During the congestion window, the number of packets dropped due to congestion control methods are counted at step 606. The counted number of dropped packets is referred to as variable C.

After dropped packets have been counted for several congestion window periods, the values for these successively counted windows can be used to determine a derivative of the overall congestion state at step 608. For example, where a first and a second window period have been counted, the counted dropped packets would be stored as values corresponding to C₁ and C₂ respectively. Thus, the dropped byte rate of change derivative dC/dt can be approximated as C₂-C₁/t, where t=the period of time over which the number of dropped packets is counted.

Further refinement of QoS treatment may be realized if the congestion metric and/or the derivative dC/dt is/are weighted. For example, if current congestion is deemed more important that the rate of change of the congestion, weight variables W₁ and W₂ corresponding respectively thereto, may be applied at step 610. For example, if current congestion is deemed to contribute 85% to the congestion state and the rate of change is deemed to contribute 15%, then the formula for the summed and weighted congestion count C would be W1×C+W2×dC/dt. This expression, W1×C+W2×dC/dt, is a method of for determining the congestion state, or congestion metric. Alternatively, only the dropped bytes counted during a given congestion measurement window period may be used as the congestion metric. Depending on the byte-threshold selected, comparing the congestion metric to the byte-threshold determines whether the channel is congested or uncongested. If the congestion metric is lower than the threshold, the channel is deemed uncongested. Likewise, if the congestion metric is greater than the threshold, then the channel is deemed to be congested.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents.

1. A method for balancing bandwidth allocation of data subscribers over a broadband network channel comprising:
classifying the subscribers into different groupings based on a long-term historical usage profile associated with each subscriber; and
assigning predetermined treatment policies to each of the subscribers based on their corresponding long term usage history profile grouping.

2. The method of claim 1 wherein a predetermined time period window is selected over which the long-term historical usage pattern is determined.

3. The method of claim 2 wherein the window is one hour.

4. The method of claim 2 wherein the window is one day.

5. The method of claim 2 wherein the window is one week.

6. The method of claim 2 wherein the window is one month.

7. The method of claim 1 wherein a subscriber is penalized based on the long term usage history profile corresponding to the subscriber.

8. The method of claim 7 wherein the subscriber is penalized if the long-term usage profile exceeds a predetermined usage level threshold corresponding to the predetermined time period.

9. A method for balancing bandwidth allocation of data subscribers over a broadband network channel comprising:
classifying the subscribers into different groupings based on a long term historical usage profile associated with each subscriber; and
identifying a channel congestion metric; and
assigning predetermined treatment policies to each of the subscribers based on their corresponding long term usage profile grouping and the channel congestion metric.

10. The method of claim 9 wherein a predetermined time period window is selected over which the historical usage pattern is determined.

11. The method of claim 10 wherein the window is one hour.

12. The method of claim 10 wherein the window is one day.

13. The method of claim 10 wherein the window is one week.

14. The method of claim 10 wherein the window is one month.

15. The method of claim 9 wherein a subscriber is penalized based on the long term usage history profile corresponding to the subscriber.

16. The method of claim 15 wherein the subscriber is penalized if the long-term usage profile exceeds a predetermined usage level threshold corresponding to the predetermined time period.

17. The method of claim 9 wherein the channel congestion metric includes a count of the number bytes corresponding to a given subscriber that are dropped during a predetermined congestion measurement window period.

18. The method of claim 17 wherein dropped bytes during a first predetermined congestion measurement window period and a second predetermined congestion measurement window period are determined and the number of dropped bytes counted for the first a second predetermined congestion measurement window periods are used to determine a dropped byte rate of change derivative.

19. The method of claim 18 wherein the dropped byte rate of change derivative and a count of the number of bytes dropped during a given congestion measurement window period are used to determine a summed and weighted congestion metric.

20. The method of claim 17 wherein a user is penalized if the channel congestion metric exceeds a predetermined congestion threshold.

21. The method of claim 18 wherein a user is penalized if the dropped byte rate of change derivative exceeds a predetermined congestion threshold.

22. The method of claim 19 wherein a user is penalized if the summed and weighted congestion metric exceeds a predetermined congestion threshold.

23. A method for balancing bandwidth allocation of data subscribers over a broadband network channel comprising:
classifying the subscribers into different groupings based on a composite long-term historical usage profile associated with each subscriber; and
assigning predetermined treatment policies to each of the subscribers based on their corresponding long term usage history profile grouping.

24. The method of claim 23 wherein a plurality of predetermined time period windows are selected over which components of the long-term historical usage pattern is determined.

25. The method of claim 24 wherein a first component window is one hour.

26. The method of claim 24 wherein a second component window is one day.

27. The method of claim 24 wherein a third component window is one week.

28. The method of claim 24 wherein a forth component window is one month.

29. The method of claim 23 wherein a subscriber is penalized based on the composite long term usage history profile corresponding to the subscriber.

30. The method of claim 29 wherein the subscriber is penalized if the composite long-term usage profile exceeds a predetermined composite usage level threshold corresponding to the predetermined time period.
